(19) United States
(12) Patent Application Publication
(10) Pub. No.: US 2010/0165503 A1
(43) Pub. Date: Jul. 1, 2010

(54) METHOD AND APPARATUS FOR RECORDING AND READING INFORMATION

(75) Inventors: Won-jong Choi, Seoul (KR); Du-il Kim, Suwon-si (KR); Ki-seok Chang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/541,274

(22) Filed: Aug. 14, 2009

(30) Foreign Application Priority Data
Dec. 30, 2008 (KR) 10-2008-0137171

(51) Int. Cl. G11B 21/02

(52) U.S. Cl. 360/75; 711/157; 711/E12.079; G9B/21.003

(57) ABSTRACT

Disclosed are information recording/reading methods. The information recording method includes forming file data and metadata regarding the file data into recording information; dividing a predetermined recording medium into a plurality of zones when a recording mode is set; and recording file data and metadata, which are to be additionally recorded, in different zones.

### CROSS-REFERENCE TO RELATED PATENT APPLICATION

This application claims the benefit of Korean Patent Application No. 10-2008-0137171, filed on Dec. 30, 2008, in the Korean Intellectual Property Office, the Disclosure of which is incorporated herein in its entirety by reference.

### BACKGROUND OF THE INVENTION

1. Field of the Invention

Methods and apparatuses consistent with the present invention relate to an information recording/reading using an optical disc as a recording medium, and more particularly, to a method and apparatus for recording and reading information and capable of minimizing the storage capacity for file system information to be additionally recorded on a write-once optical medium.

2. Description of the Related Art

Recently, the technology for recording files on a large-capacity recording medium has been spread. Also, various formats for recording files on the large-capacity recording medium have been suggested.

Due to large storage capacity, low prices, stable keeping, etc., write-once optical media are used in camcorders, digital video recorders (DVRs), personal video recorders (PVRs), and servers/PCs. However, since recording is performed only once, a write-once optical medium may not easily use its entire recording capacity.

Also, a write-once optical medium-type camcorder has a very large size of metadata of a file system, which is additionally recorded whenever an edit function is performed. For example, in a 25 GB Blu-ray recordable disc adopting a universal disc format (UDF), metadata of a file system use at least 800 blocks whenever an edit function is performed. In this case, the metadata is always additionally recorded on a recording medium.

Accordingly, a solution for efficient use of a recording medium of an optical medium-type camcorder that frequently performs an edit function is required.

### SUMMARY OF THE INVENTION

Exemplary embodiments of the present invention provides a method and apparatus for recording and reading information and capable of minimizing the storage capacity for file system information to be additionally recorded on a write-once optical medium.

According to an aspect of the present invention, there is provided an information recording method including forming file data and metadata regarding the file data into recording information; dividing a predetermined recording medium into a plurality of zones when a recording mode is set; and recording file data and metadata, which are to be additionally recorded, in different zones.

According to another aspect of the present invention, there is provided an information reading method in which file data and metadata, which are to be additionally recorded, are recorded in different zones, the information reading method including obtaining the metadata regarding the file data from a metadata zone; detecting start and end addresses of the file data from the metadata zone; setting the detected start address as a start location of the file data in a file data zone; and reading the file data from the file data zone in predetermined blocks with reference to the set start location of the file data.

According to another aspect of the present invention, there is provided an information recording and reading apparatus including a recording medium; and a control unit for dividing the recording medium into a plurality of zones when a recording mode is set, recording file data and metadata, which are to be additionally recorded, in different zones, and reading the file data from a file data zone in predetermined blocks with reference to a start location of the file data, which is detected from a metadata zone of the recording medium, when a reading mode is set.

### BRIEF DESCRIPTION OF THE DRAWINGS

The above and other features and aspects of the present invention will become more apparent by describing in detail exemplary embodiments thereof with reference to the attached drawings in which:

FIG. 1 is a block diagram of an information recording/reading apparatus for a write-once optical medium, according to an exemplary embodiment of the present invention;

FIG. 2 is a structural diagram of a file format on a recording medium, according to an exemplary embodiment of the present invention;

FIGS. 3A through 3E are conceptual diagrams of a recording medium when information is recorded, according to an exemplary embodiment of the present invention;

FIGS. 4A through 4C are conceptual diagrams of a recording medium when an additional file is recorded, according to a conventional information recording method;

FIG. 4D is a graph showing a correlation between a metadata zone and the number of edited files on an optical medium, according to an exemplary embodiment of the present invention;

FIG. 5 is a flowchart of an information recording method according to an exemplary embodiment of the present invention;

FIG. 6 is a flowchart of a process of formatting a disc, which is performed in the method illustrated FIG. 5, according to an exemplary embodiment of the present invention;

FIG. 7A is a flowchart of a process of recording metadata, which is performed in the method illustrated FIG. 5, according to an exemplary embodiment of the present invention;

FIG. 7B is a flowchart of a process of recording file data, which is performed in the method illustrated FIG. 5, according to an exemplary embodiment of the present invention;

FIG. 8 is a flowchart of an information reading method according to an exemplary embodiment of the present invention; and

FIGS. 9A through 9D are structural diagrams of file formats on a recording medium, according to another exemplary embodiment of the present invention.

### DETAILED DESCRIPTION OF THE INVENTION

Hereinafter, the present invention will be described in detail by explaining embodiments of the invention with reference to the attached drawings.

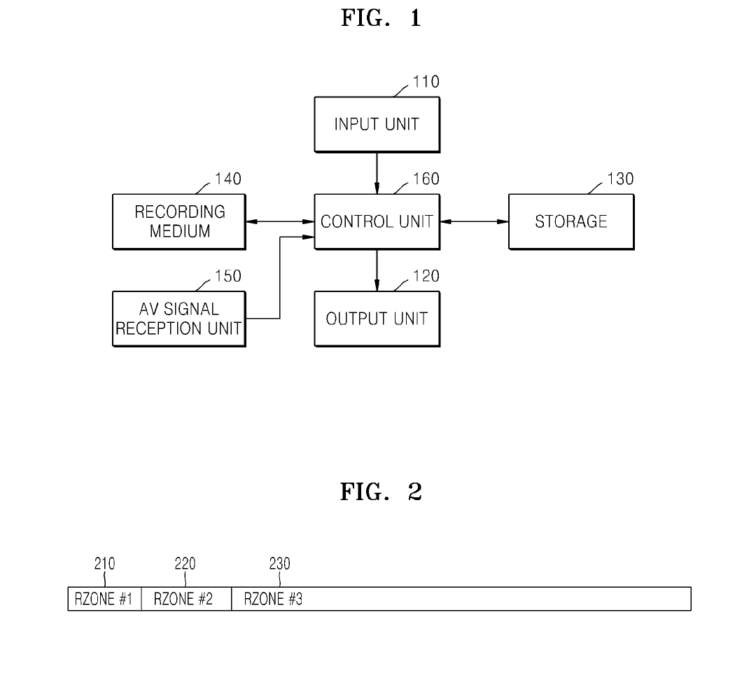

FIG. 1 is a block diagram of an information recording/reading apparatus for a write-once optical medium, according to an exemplary embodiment of the present invention;

Referring to FIG. 1, the information recording/reading apparatus according to the current exemplary embodiment includes an input unit 110, an output unit 120, a storage 130, a recording medium 140, an audio/video (AV) signal reception unit 150, and a control unit 160.

The input unit 110 corresponds to a touch screen, a remote controller, buttons, etc. and generates control instructions selected by a user.

The output unit 120 corresponds to a display device, a speaker, etc. and outputs AV data and outputs execution messages for controlling various functions.

The storage 130 stores a program for driving the control unit 160.

The recording medium 140 corresponds to a write-once optical disc such as a Blu-ray recordable disc or a digital versatile disc (DVD), and records universal disc format (UDF) data, information/signal file data, and metadata in different zones.

The AV signal reception unit 150 receives AV bitstreams obtained by a camera.

When a recording mode instruction is received from the input unit 110, the control unit 160 divides the recording medium 140 into a plurality of zones and records file data and metadata, which are to be additionally recorded, in different zones, such as in a metadata zone and a file data zone, of the recording medium 140.

Also, when a reading mode instruction is received from the input unit 110, the control unit 160 detects start and end addresses of the file data from the metadata zone of the recording medium 140 and reads the file data recorded in the file data zone, in predetermined blocks with reference to the detected start address of the file data.

Also, the control unit 160 displays a recording start/completion message or a reading start/completion message on the output unit 120.

Also, the control unit 160 includes an optical disc driver for driving the write-once optical disc of the recording medium 140.

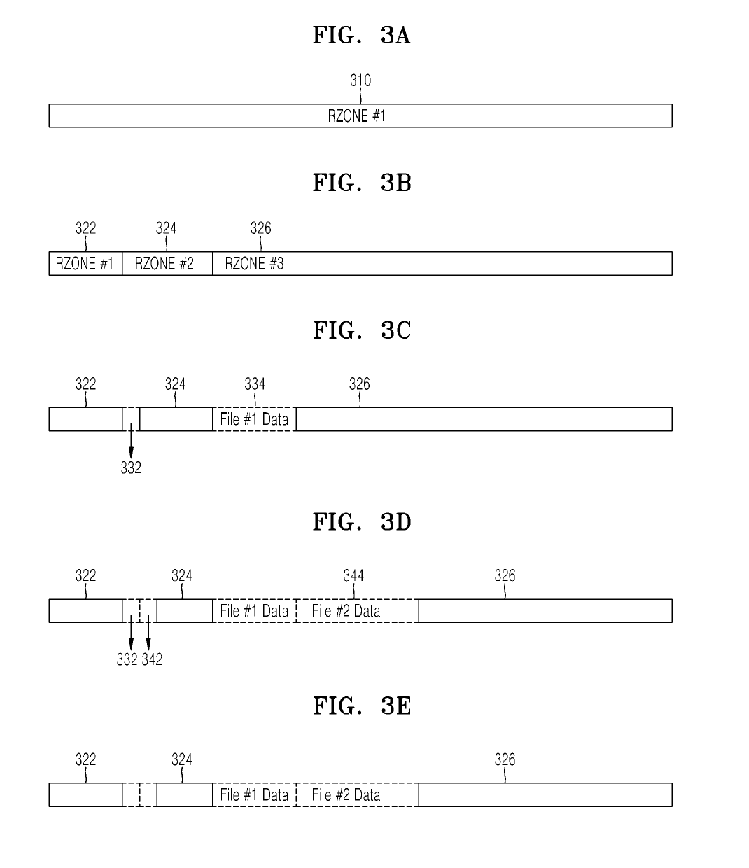

FIG. 2 is a structural diagram of a file format on a recording medium, according to an exemplary embodiment of the present invention.

In the exemplary embodiment of present invention, a write-once medium has recording restrictions as described below.

\textcircled{1} A write-once medium should record data in continuous units.

\textcircled{2} UDF data should be recorded in a predetermined zone from which a disc starts.

In order to allow incremental recording and to minimize the storage capacity for metadata according to file recording under the above recording restrictions, a disc is divided into a UDF zone, a metadata zone, and a file data zone.

Referring to FIG. 2, an optical medium is formatted to have a first reserved zone 210, a second reserved zone 220, and a third reserved zone 230.

The first reserved zone 210 is a UDF zone for a UDF file system.

The second reserved zone 220 is a metadata zone for storing metadata of a file system, which is used to create/read/write files. In this case, a piece of metadata is created for each file.

The third reserved zone 230 is a file data zone for storing file data.

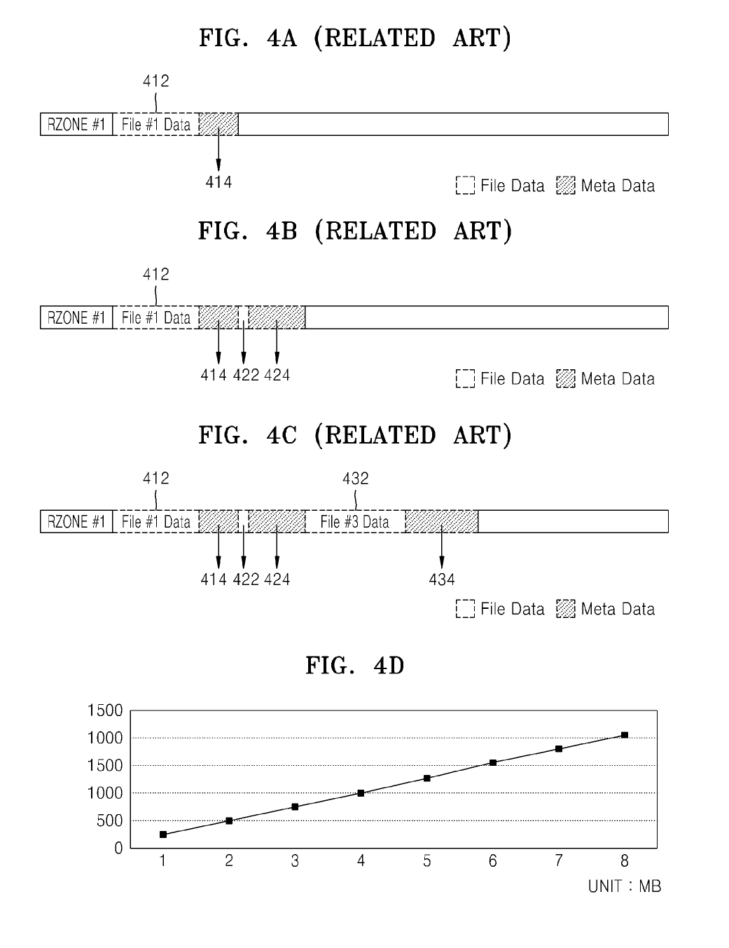

FIGS. 3A through 3E are conceptual diagrams of a write-once optical medium when information is recorded, according to an exemplary embodiment of the present invention.

Referring to FIG. 3A, an initial recording medium has only one reserved zone 310. Thus, the initial recording medium should be formatted to use a file system.

Referring to FIG. 3B, the recording medium is divided into a first zone 322, a second zone 324, and a third zone 326 in order to use the file system. In more detail, the first zone 322 corresponds to a UDF zone, the second zone 324 corresponds to a metadata zone, and the third zone 326 corresponds to a file data zone.

Referring to FIG. 3C, when one piece of file data, i.e., first file data 334, is recorded on the recording medium, first metadata 332 regarding the first file data 334 is recorded in the second zone 324 and the first file data 334 is recorded in the third zone 326. In this case, the size of the first metadata 332 generated when the first file data 334 is recorded on the recording medium is 16 blocks (1 block=2048 bytes).

Referring to FIG. 3D, when another piece of file data, i.e., second file data 344, is recorded on the recording medium, second metadata 342 regarding the second file data 344 is recorded in the second zone 324 next to the first metadata 332 and the second file data 344 is recorded in the third zone 326 next to the first file data 334.

Referring to FIG. 3E, when data recording on the recording medium is completed, a UDF file system is recorded in the first zone 322 for compatibility with other devices.

Ultimately, according to the current exemplary embodiment, recording/reading in units of files may be performed on the write-once medium n times.

Thus, the storage capacity for metadata to be additionally recorded when an optical medium-type camcorder performs an edit function may be minimized and usable zones according to various devices/applications may be provided.

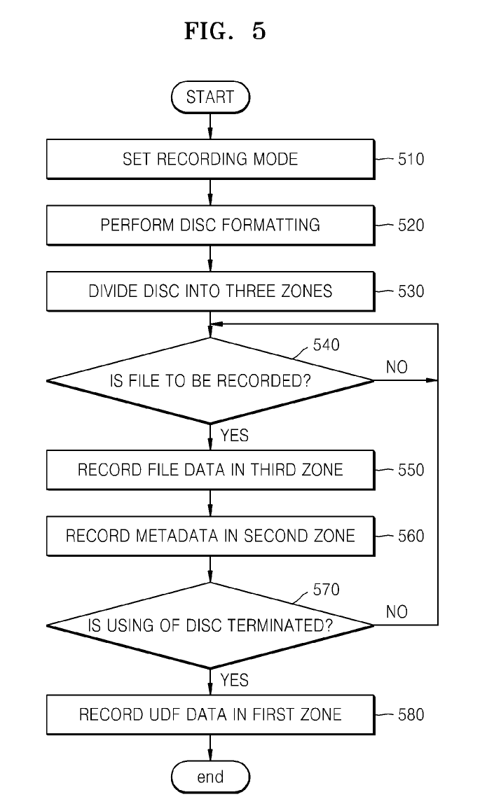

FIGS. 4A through 4C are conceptual diagrams of a recording medium when an additional file is recorded, according to a conventional information recording method.

A conventional recording medium format has only one recording zone.

Referring to FIG. 4A, when a first file is recorded, first file data 412 and first metadata 414 are recorded on the recording medium.

Referring to FIG. 4B, when a second file is additionally recorded, second file data 422 and second metadata 424 are additionally recorded on the recording medium in addition to the first file data 412 and the first metadata 414.

Referring to FIG. 4C, when a third file is additionally recorded, third file data 432 and second metadata 434 are additionally recorded on the recording medium in addition to the first file data 412, the first metadata 414, the second file data 422, and the second metadata 424.

Thus, according to the conventional information recording method, the size of metadata of a file system greatly increases whenever file data is additionally recorded.

FIG. 4D is a graph showing a correlation between a metadata zone and the number of edited files on an optical medium, according to an embodiment of the present invention.

Referring to FIG. 4D, a metadata zone of each edited file uses 32 KB (2 KB (information)+30 KB).

Thus, the correlation between the size of the metadata zone and a maximum number of times of available editing is as described below.

Maximum Number of Times of Available Editing=Size of Metadata Zone/32 KB

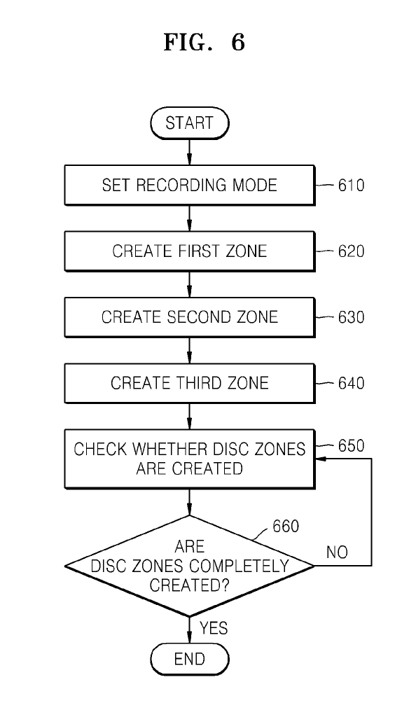

FIG. 5 is a flowchart of an information recording method according to an embodiment of the present invention.

Recording information includes file data and metadata regarding the file data.

Referring to FIG. 5, initially, when an edited file or an AV stream file is to be recorded on an optical disc, a recording mode is set (operation 510).

Then, disc formatting is performed (operation 520) and the optical disc is divided into three zones, i.e., a first zone for UDF data, a second zone for metadata, and a third zone for file data (operation 530).

Then, it is checked whether a recording operation of the edited file (or the AV stream file) is to be performed (operation 540).

Then, if the recording operation of the edited file (or the AV stream file) is to be performed, file data is recorded in the third zone (operation 550).

Then, metadata regarding the file data is recorded in the second zone (operation 560). In this case, the metadata includes a file creation date, a data size, a data path, etc.

Then, it is checked whether using of the optical disc is terminated or no storage space is left (operation 570).

Then, if using of the optical disc is terminated or no storage space is left, a disc finalizing operation is performed. In more detail, if using of the optical disc is terminated or no storage space is left, partition and file information appropriate for a UDF is recorded in the first zone (operation 580).

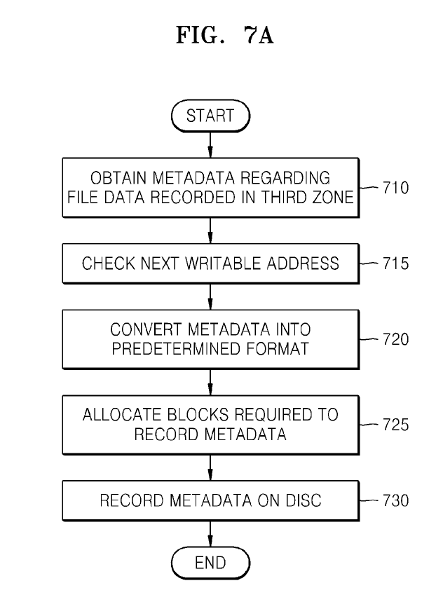

FIG. 6 is a flowchart of a process of formatting a disc, which is performed in the method illustrated FIG. 5, according to an embodiment of the present invention.

Referring to FIG. 6, initially, if a recording mode is set (operation 610), a first zone, a second zone, and a third zone are sequentially created on the disc (operation 620, 630, 640).

Then, it is checked whether the disc zones are created (operation 650). In this case, if the disc zones are completely created (operation 660), the process is terminated. Otherwise, the process returns to operation 650.

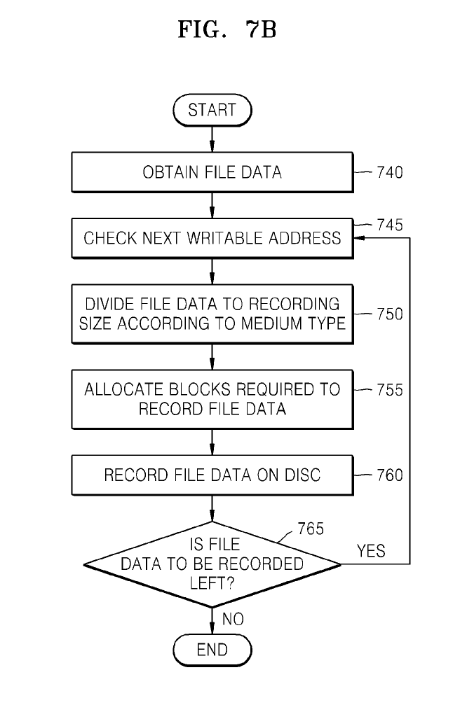

FIG. 7A is a flowchart of a process of recording metadata, which is performed in the method illustrated FIG. 5, according to an embodiment of the present invention.

Referring to FIG. 7A, metadata regarding file data recorded in a third zone of a disc is obtained (operation 710).

Then, a next writable address is checked in a second zone of the disc (operation 715).

Then, the obtained metadata is converted into a predetermined format (operation 720).

Then, blocks required to record the metadata are allocated (operation 725). For example, a Blu-ray recordable disc allocates blocks in units of 32 blocks.

Then, the metadata is recorded on the next writable address checked in the second zone of the disc (operation 730).

FIG. 7B is a flowchart of a process of recording file data, which is performed in the method of in FIG. 5, according to an embodiment of the present invention.

Referring to FIG. 7B, initially, file data such as edit information or an AV stream is obtained (operation 740).

Then, a next writable address is checked in a third zone of a disc (operation 745).

Then, the file data is divided to a recording size according to a medium type (operation 750). For example, a Blu-ray recordable disc divides the file data in units of 32 blocks and a DVD divides the file data in units of 16 blocks.

Then, blocks required to record the file data are allocated (operation 755).

Then, the file data is recorded on the next writable address checked in the third zone of the disc (operation 760).

Then, it is checked whether file data to be recorded is left (operation 765).

In this case, if file data to be recorded is left, the process returns to operation 745.

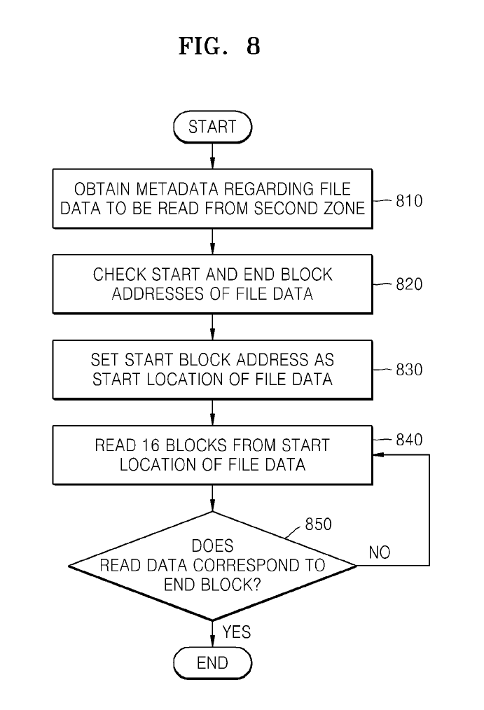

FIG. 8 is a flowchart of an information reading method according to an embodiment of the present invention.

Referring to FIG. 8, initially, metadata regarding file data to be read is obtained from a second zone (metadata zone) of a disc (operation 810).

Then, start and end block addresses of the file data are detected from the second zone (metadata zone) of the disc (operation 820).

Then, the detected start block address of the file data is set as a start location of the file data in a third zone (file data zone) of the disc (operation 830).

Then, the file data in the third zone (file data zone) of the disc is read in units of 16 blocks according to the set start location of the file data (operation 840).

Then, it is checked whether a location of the read file data corresponds to an end block (operation 850).

In this case, if the location of the read file data does not correspond to the end block, the information reading method returns to operation 840 and the file data is read until the location of the read file data corresponds to the end block.

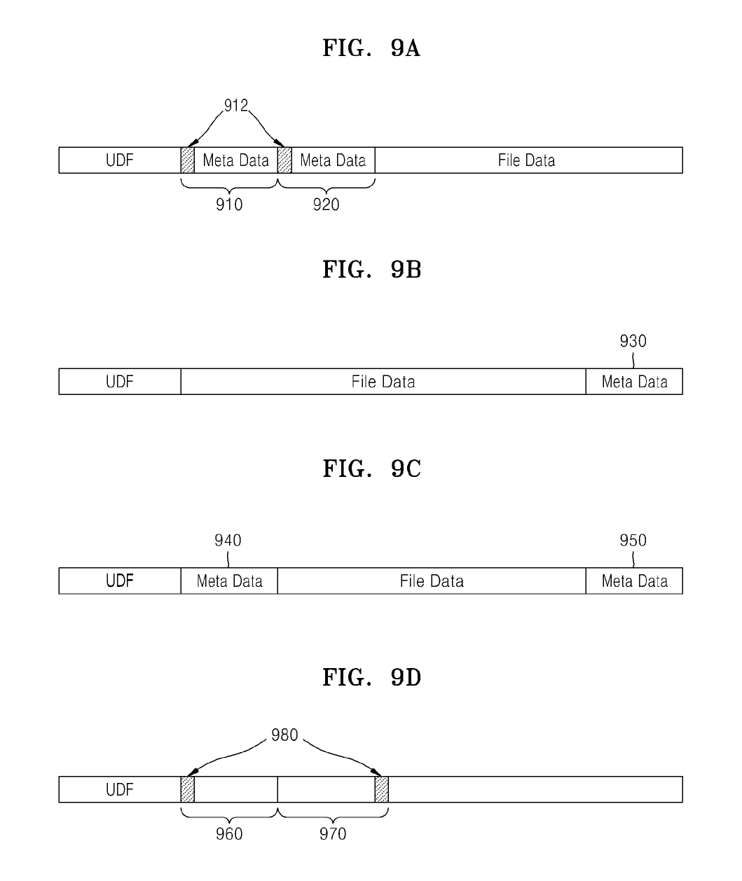

FIGS. 9A through 9D are structural diagrams of file formats on a recording medium, according to another embodiment of the present invention.

Referring to FIG. 9A, a disc is divided into four or more zones, and metadata 912 regarding file data, which are generated when the file data is created, are recorded in at least two metadata zones 910 and 920. Thus, data stability and restoration possibility may be improved by repeatedly arranging metadata zones on the disc.

Referring to FIGS. 9B and 9C, a location of a metadata zone may be set to be after a file data zone (930), before and after the file data zone (940 and 950), or in the middle of the file data zone (not shown). Thus, the distance of pick-up motion may be minimized by changing the location of the metadata zone.

Referring to FIG. 9D, a metadata zone of a disc is divided according to information files. In more detail, metadata 980 is repeatedly recorded in a file data zone 970 in addition to a metadata zone 960. Thus, when some file data is lost, other file data may be restored, by dividing the metadata zone according to file data.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy discs, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An information recording method comprising:
forming file data and metadata regarding the file data into recording information;
dividing a recording medium into a plurality of zones if a recording mode is set; and
recording the file data and the metadata in different zones of the plurality of zones.

2. The information recording method of claim 1, wherein the dividing of the recording medium comprises dividing the recording medium into a universal disc format (UDF) zone, a metadata zone, and a file data zone if the recording mode is set.

3. The information recording method of claim 2, wherein the metadata are recorded in at least the metadata zone and another zone.

4. The information recording method of claim 2, wherein a location of the metadata zone is set to be before and after the file data zone.

5. The information recording method of claim 2, wherein the metadata zone is divided according to information files.

6. The information recording method of claim 1, wherein the recording of the file data and the metadata comprises:
checking whether the recording medium receives a file recording instruction; and
if the file recording instruction is received, recording the file data and the metadata in different zones of the plurality of zones.

7. The information recording method of claim 1, wherein the recording of the metadata comprises:
obtaining the metadata regarding the file data;
checking a next writable address in a metadata zone that non-overlaps a file data zone on the recording medium;
converting the obtained metadata into a predetermined format; and
recording the converted metadata at the next writable address.

8. The information recording method of claim 1, wherein the recording of the file data comprises:
obtaining the file data;
checking a next writable address in a file data zone that that non-overlaps a metadata zone on the recording medium;
dividing the file data into recording size units according to a type of the recording medium; and
recording the divided file data at the next writable address.

9. The information recording method of claim 1, further comprising recording universal disc format (UDF) data in a predetermined zone after the recording information is completely recorded on the recording medium.

10. The information recording method of claim 1, further comprising recording partition information and file information in a universal disc format (UDF) zone if no storage space is left on another zone of the recording medium.

11. The information recording method of claim 1, wherein the recording medium is a write-once optical disc.

12. An information reading method in which file data and metadata are recorded in different zones, the information reading method comprising:
obtaining the metadata regarding the file data, from a metadata zone;
detecting a start address and an end address of the file data from the metadata zone;
setting the detected start address as a start location of the file data in a file data zone; and
reading the file data from the file data zone in predetermined blocks with reference to the set start location of the file data.

13. An information recording and reading apparatus comprising:
a recording medium; and
a control unit which divides the recording medium into a plurality of zones when a recording mode is set, recording file data and metadata in different zones of the plurality of zones, and reading the file data from a file data zone in predetermined blocks with reference to a start location of the file data, which is detected from a metadata zone of the recording medium, if a reading mode is set.

14. The information recording and reading apparatus of claim 13, wherein the recording medium is a write-once optical disc.

15. A computer readable recording medium having recorded thereon a computer program for executing the information recording method of claim 1.

16. A computer readable recording medium having recorded thereon a computer program for executing the information reading method of claim 12.

17. The information recording method of claim 1, wherein the file data and the metadata are first file data and first metadata, respectively, the first file data is recorded in a first zone of the plurality of zones, the first metadata is recorded in a second zone of the plurality of zones,
a second file data is recorded in the first zone and a second metadata of the second file data, is recorded in the second zone, and
the recording medium is a write-once recordable medium.
